(19) United States
(12) Patent Application Publication
(10) Pub. No.: US 2018/0020279 A1
(43) Pub. Date: Jan. 18, 2018

(54) MULTIFUNCTIONAL BLUETOOTH DEVICE

(71) Applicant: VERICO INTERNATIONAL CO., LTD., New Taipei City (TW)

(72) Inventor: Huei-Chung Hsiao, New Taipei City (TW)

(21) Appl. No.: 15/249,464

(22) Filed: Aug. 28, 2016

(30) Foreign Application Priority Data
Jul. 15, 2016 (TW) 105122377

(51) Int. Cl. H04R 1/10

(52) U.S. Cl. CPC H04R 1/1041; H04R 1/1025; H04R 1/1008; H04R 2420/09; H04R 2420/07

(57) ABSTRACT

A multifunctional Bluetooth device includes a first speaker device, a second speaker device, and a power supply device. The first speaker device includes a first connection assembly and a wireless transmission element. The second speaker device includes a second connection assembly and an electricity storage element. The power supply device includes a third connection assembly. The first connection assembly, the second connection assembly, and the third connection assembly may be selectively and alternatively connected to and combined with one another such that the combined configuration allows for information connection with an electronic device through the wireless transmission element or the power supply device. In this way, an advantage of unrestrained changefulness may be achieved to help reduce purchasing costs for a user.

### TECHNICAL FIELD OF THE INVENTION

The present invention relates generally to a multifunctional Bluetooth device, and more particularly to a multifunctional Bluetooth device that possesses unrestrained changefulness of use and helps lower down purchasing costs for consumers.

### DESCRIPTION OF THE PRIOR ART

Various different fixed-style headphones are known and commercially available from the market. The fixed-style headphones are generally classified as ear-muffles headphones and ear-bud headphones, and may also be classified as wired ear-muffles headphones and wireless ear-muffles headphones, wired ear-bud headphones, and wireless ear-bud headphones. The ear-muffles headphones provide the best effect of sound isolation and are suitable for being worn for a long period of time, but are generally bulky and hard to carry. On the other hand, the ear-bud headphones are small and easy to carry, but may cause discomfort of ears of users and are thus not suitable for being worn for a long period of time.

Consumers may have different demands for the fixed-style headphone based on applications. In addition, the style-fixed headphones generally have fixed and invariable functionality so that many consumers need to own several headphones of different styles, such as a headset including a wireless ear-bud type headphone for telephone chatting and a wired ear-muffles headphone for listening music with a computer. This would cause an unnecessary increase of purchasing costs.

Thus, it is a challenge of those involved in this field to provide a solution that overcomes the above issues and problems.

### SUMMARY OF THE INVENTION

The present invention is aimed to provide a multifunctional Bluetooth device that features unrestrained changefulness of use and helps lower down purchasing costs for consumers.

The primary object of the present invention is unrestrained changefulness as desired by a user.

Another object of the present invention is reduction of costs for repeated purchases for a user.

To achieve the above objects, the present invention comprises at least one first speaker device, at least one second speaker device, and at least one power supply device. The first speaker device comprises at least one wireless transmission element arranged therein and is provided, at one side thereof, with at least one first connection assembly. The second speaker device comprises at least one electricity storage element arranged therein and is provided, at one side thereof, with at least one second connection assembly that is selectively connectable to the first connection assembly. The power supply device is provided, at one side thereof, with at least one third connection assembly that is selectively and alternatively connectable to the first connection assembly or the second connection assembly.

Thus, a user, if desired, may connect the first connection assembly of the first speaker device to the second connection assembly of the second connection assembly to allow the first speaker device to acquire electrical power from the electricity storage element and using the wireless transmission element to conduct information transmission so that the second speaker device is also allowed to play or broadcast sounds; and may alternatively, if desired, connect the first connection assembly of the first speaker device to the third connection assembly of the power supply device to acquire electrical power therefrom and the first speaker device may perform information transmission through the wireless transmission element or the power supply device for playing or broadcasting sounds; and may alternatively, if desired, connect the second connection assembly of the second speaker device to the third connection assembly of the power supply device to allow the second speaker device to perform information transmission through the power supply device for playing or broadcasting sounds. Thus, the present invention allows for various combinations to meet the needs for different applications and may help reduce the expenditure that a user may spend. With the above technical solution, the drawbacks of the conventional style-fixed headphones that the functionality is fixed and invariable and may not suit for various needs for different applications, leading to additional expenditure for general consumers, can be overcome and achieve a practical improvement for unrestrained changefulness and reduction of purchasing costs for the consumers.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a first preferred embodiment of the present invention.

FIG. 2 is a perspective view illustrating a use of the first preferred embodiment of the present invention.

FIG. 3 is a perspective view showing a second preferred embodiment of the present invention.

FIG. 4A is a perspective view showing a use of the second preferred embodiment of the present invention.

FIG. 4B is a perspective view showing a use of the second preferred embodiment of the present invention.

FIG. 5 is a perspective view showing a third preferred embodiment of the present invention.

FIG. 6 is a perspective view illustrating a use of the third preferred embodiment of the present invention.

FIG. 7 is a perspective view illustrating a use of the third preferred embodiment of the present invention.

FIG. 8 is a perspective view illustrating a use of a fourth preferred embodiment of the present invention.

FIG. 9 is a perspective view illustrating a use of a fifth preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

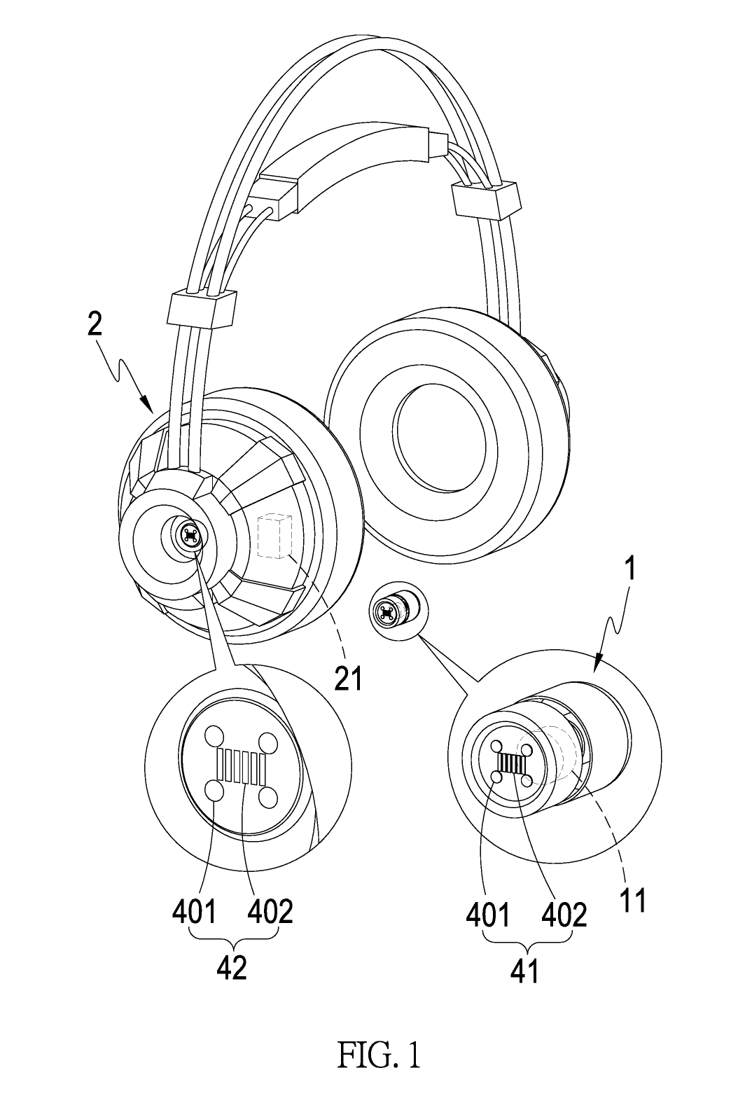

Referring to FIG. 1, which is a perspective view showing a first preferred embodiment of the present invention, as shown in the drawing, the present invention comprises at least one first speaker device 1 and at least one second speaker device 2. The first speaker device 1 is provided, at one side thereof, with at least one first connection assembly 41. The first speaker device 1 comprises at least one wireless transmission element 11 arranged therein. In the instant embodiment, the first speaker device 1 is structured as an ear-bud type headphone or an ear-fitting headphone and the wireless transmission element 11 is embodied as or comprises a Bluetooth element. The wireless transmission element 11 is connectable, for wireless information communication, with at least one electronic device described below. In the instant embodiment, the second speaker device 2 is structured or embodied as a head-wearing headphone. The second speaker device 2 comprises at least one electricity storage element 21 arranged therein and the second speaker device 2 is provided, at one side thereof, with at least one second connection assembly 42 that is removably connectable with the first connection assembly 41. The first connection assembly 41 and the second connection assembly 42 each comprise at least one magnetic element 401 for mutual connection with each other and at least one transmission conductor 402 for electrical connection and arranged on one side of the magnetic element 401. The above is provided for illustrating one example of feasible configurations of the present invention and the present invention is not limited to such an example.

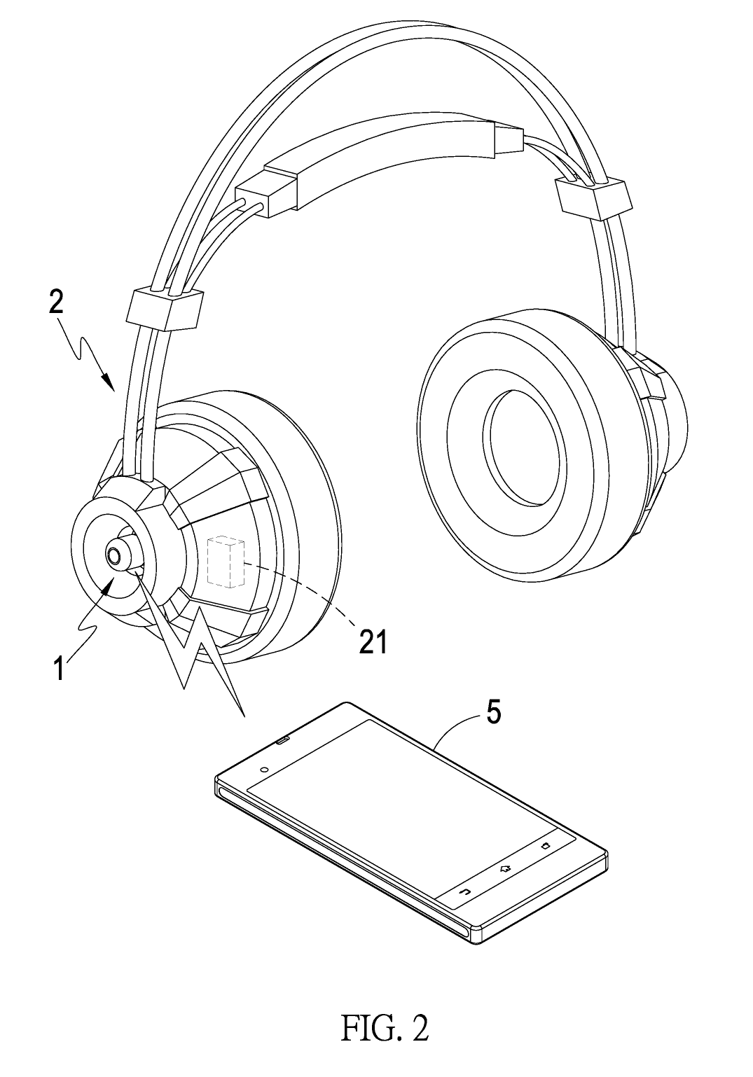

Referring collectively to FIGS. 1 and 2, which are respectively a perspective view showing a first preferred embodiment of the present invention and a perspective view illustrating a use of the first preferred embodiment of the present invention, as shown in the drawings, to use the present invention, the first connection assembly 41 and the second connection assembly 42 are selectively connected together through the magnetic elements 401 so that the first speaker device 1 is mounted to and fixed on the second speaker device 2. Mutual electrical connection is established between the first connection assembly 41 and the second connection assembly 42 through the transmission conductors 402 so that electrical power may be supplied from the electricity storage element 21 arranged in the second speaker device 2 to the first speaker device 1 and the wireless transmission element 11 arranged in the first speaker device 1 is allowed to establish wireless information communication with an electronic device 5 for accessing or acquiring music data therefrom. In the instant embodiment, a mobile phone is taken as an example of the electronic device 5 and the music data is transmitted through the first connection assembly 41 and the second connection assembly 42 to the second speaker device 2 for sound playing or broadcasting so that the present invention is used and operated as a wireless ear-muffles style device.

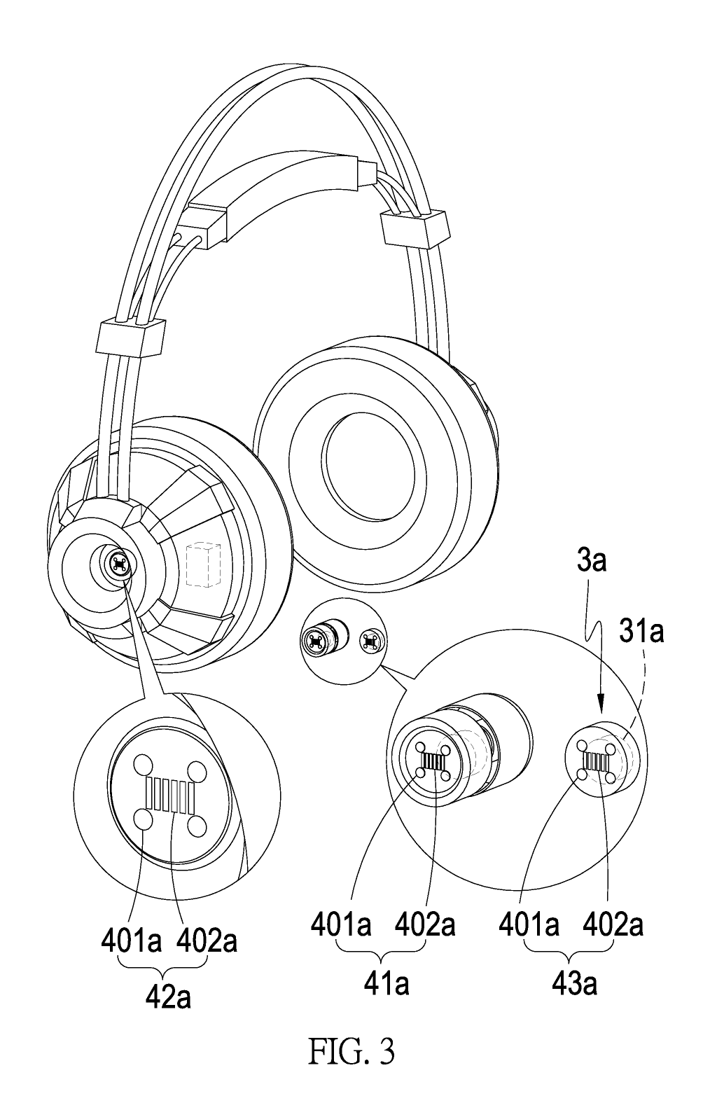

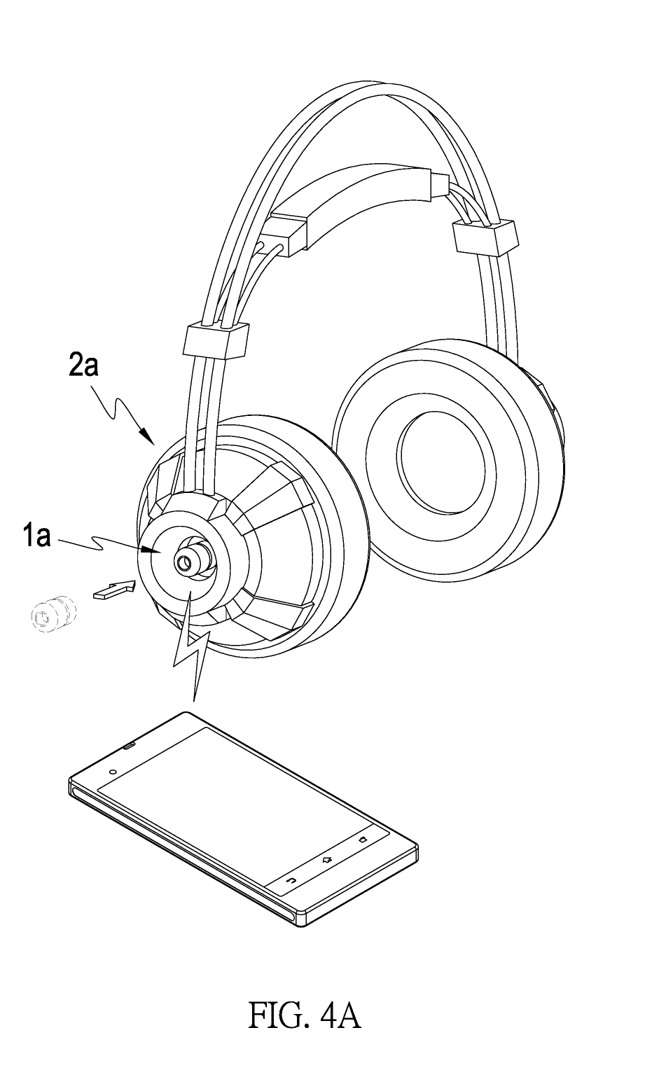

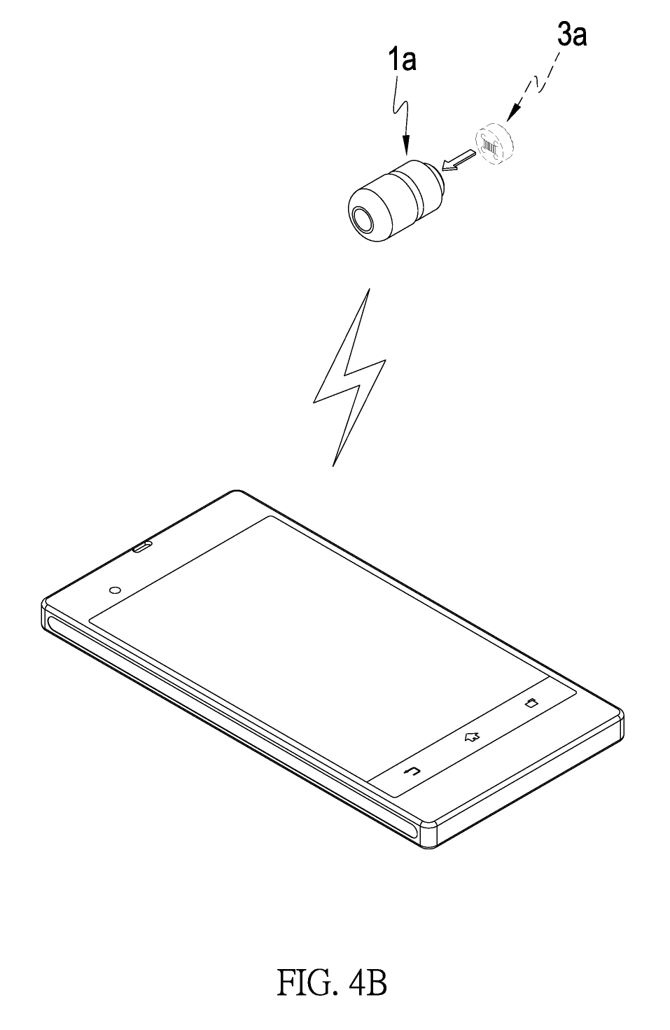

Referring to FIGS. 3, 4A, and 4B, which are respectively a perspective view showing a second preferred embodiment of the present invention and perspective views showing uses of the second preferred embodiment of the present invention, as shown in the drawings, the instant embodiment is generally similar to the previous embodiment and a difference resides in that the instant embodiment further comprises at least one power supply device 3a. The power supply device 3a is provided, at one side thereof, with at least one third connection assembly 43a that is composed of at least one magnetic element 401a and at least one transmission conductor 402a. The third connection assembly 43a is selectively or optionally connectable to the first connection assembly 41a or the second connection assembly 42a. The power supply device 3a comprises at least one electricity storage element 31a, and in the instant embodiment, the power supply device 3a is embodied as a power source.

Thus, in addition to mounting the first speaker device 1a to the second speaker device 2a to serve as a wireless ear-muffles style device, the present invention may also be used by further including the power supply device 3a that is selectively mounted and fixed through mutual connection between magnetic elements 401a of the third connection assembly 43a and the first connection assembly 41a so that the power supply device 3a is selectively attached to the first speaker device 1a and allowing the power supply device 3a to supply electrical power to the first speaker device 1a through transmission conductors 402a of the third connection assembly 43a and the first connection assembly 41a for serving and operating as a wireless ear-bud style device.

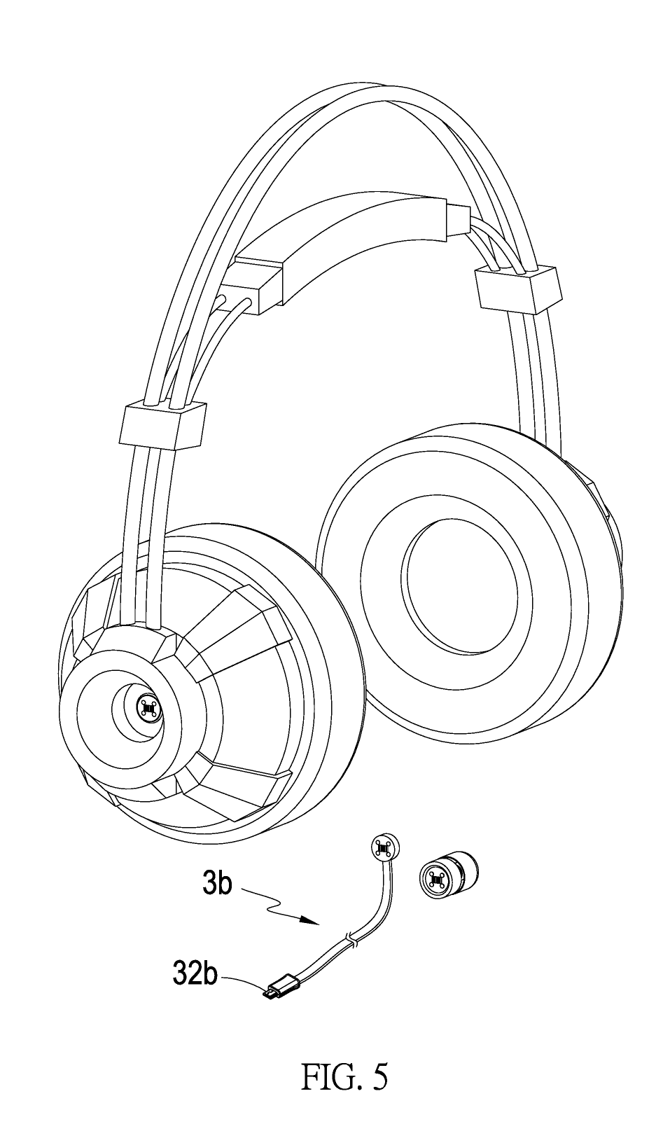

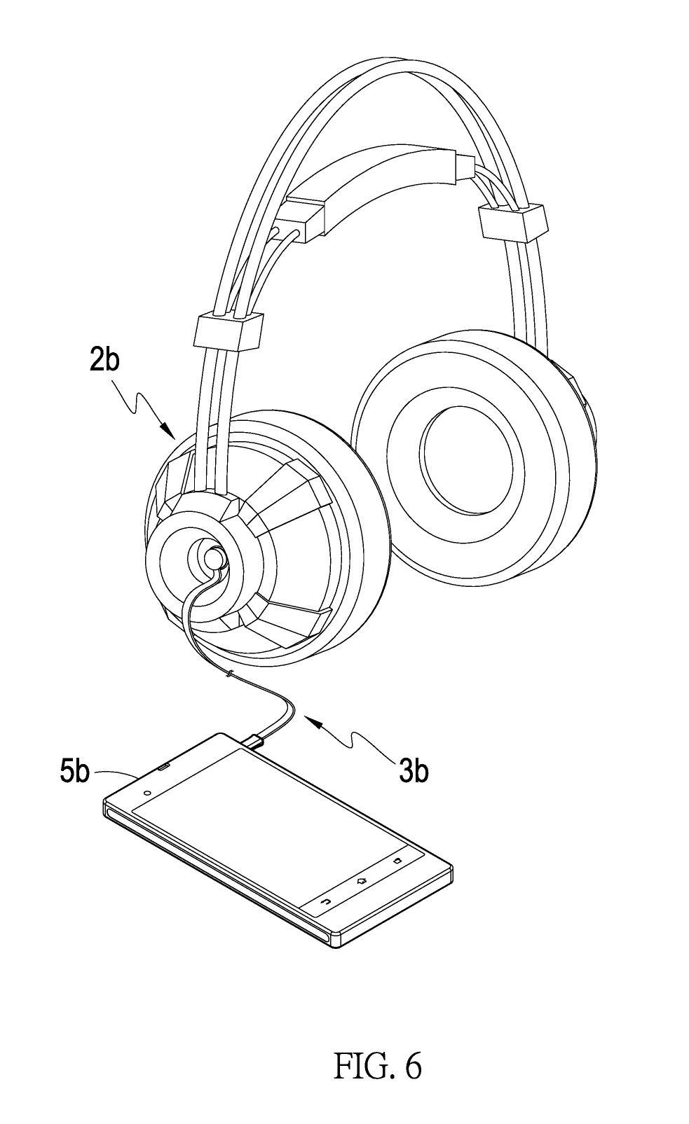

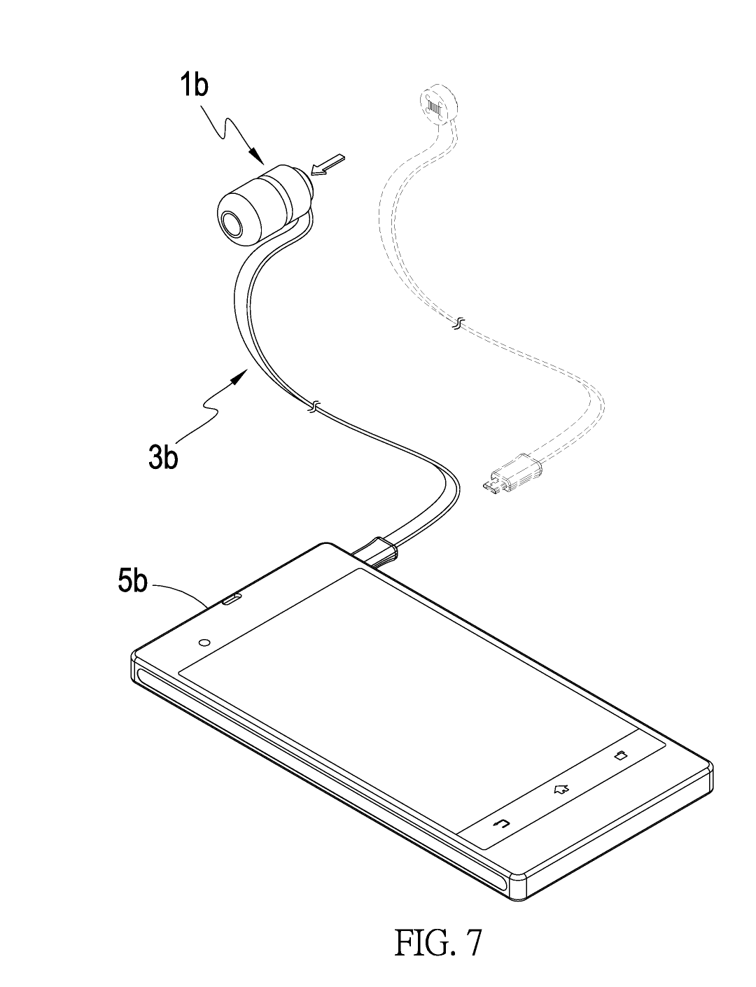

Referring to FIGS. 5, 6, and 7, which are respectively a perspective view showing a third preferred embodiment of the present invention and perspective views illustrating uses of the third preferred embodiment of the present invention, as shown in the drawings, the instant embodiment is generally similar to the previous embodiment and a difference resides in that the instant embodiment is alternatively embodied with a power supply device 3b serving as a transmission line. The power supply device 3b has an end that is provided with at least one connection element 32b. The connection element 32b can be of a specification of one of Universal Serial Bus (USB), micro USB, mini USB, 30-pin connector, Lightning connector, and TRS connector. In the instant embodiment, a micro USB is taken as an example for illustration of electrical connection with at least one electronic device 5b so that in addition to serving as a wireless ear-muffles style device and/or a wireless ear-bud style device, the present invention may be used as a wired ear-muffles device by having the power supply device 3b connecting the second speaker device 2b and the electronic device 5b or the present invention may be used as a wired ear-bud device by having the power supply device 3b connecting the first speaker device 1b and the electronic device 5b.

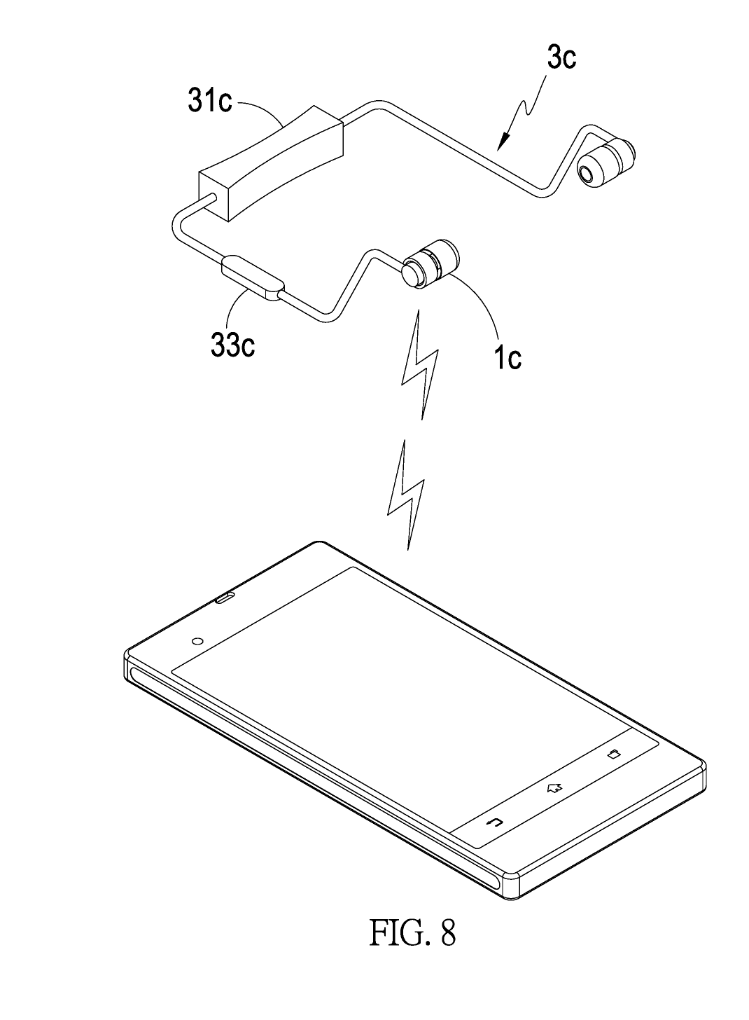

Referring to FIG. 8, which is a perspective view illustrating a use of a fourth preferred embodiment of the present invention, as shown in the drawing, the instant embodiment is generally similar to the previous embodiment and a difference resides in that the instant embodiment comprises a power supply device 3c that also serves as a suspension device. The power supply device 3c is structured to comprise at least one sound collection element 33c so that the present invention can be suspended on the neck of a user and an electricity storage element 31c supplies electrical power to the sound collection element 33c and the first speaker device 1c. Due to electrical connection between the first speaker device 1c and the power supply device 3c, conversation or sound recording can be made through the sound collection element 33c.

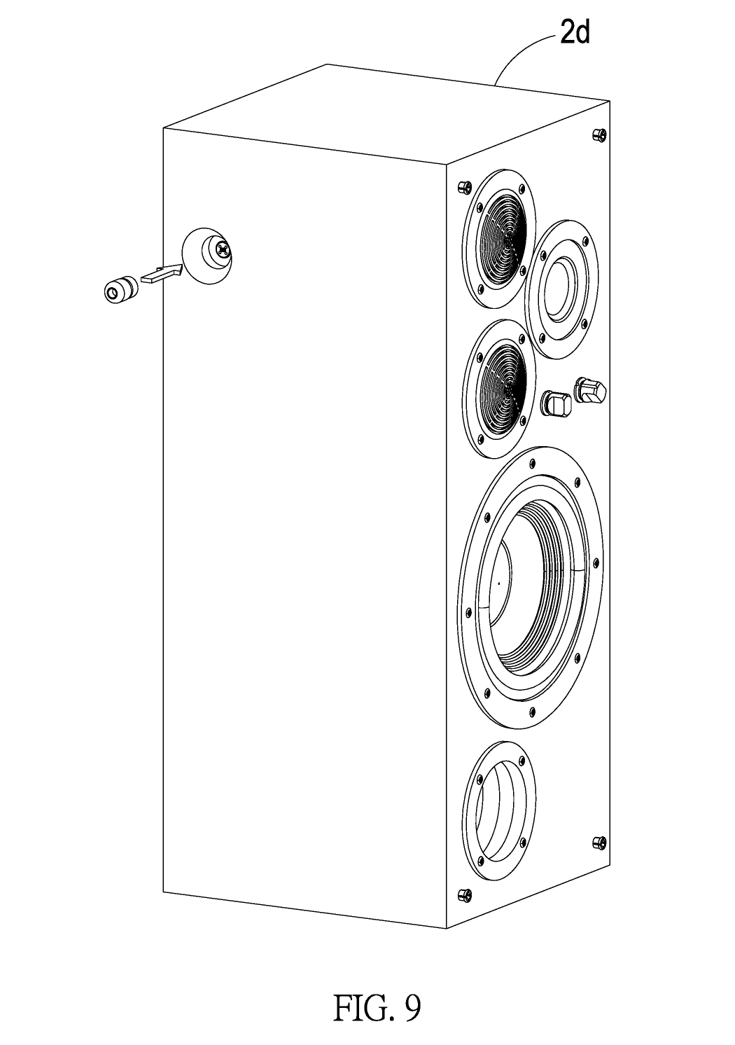

Referring to FIG. 9, which is a perspective view illustrating a use of a fifth preferred embodiment of the present invention, as shown in the drawing, the instant embodiment is generally similar to the previous embodiment and a difference resides in that the instant embodiment is structured to comprise a second speaker device 2d that is a loud speaker. This illustrates unrestrained changefulness of the present invention.

Thus, the present invention provides a multifunctional Bluetooth device that improves the prior art based on the following technical feature, where a first speaker device 1, a second speaker device 2, and/or a power supply device 3a are allowed to connect to each other in a flexible and unrestrained manner so that the present invention realizes unrestrained changefulness and helps reduces purchasing costs for consumers.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A multifunctional Bluetooth device, comprising:
at least one first speaker device, which is provided, at one side thereof, with at least one first connection assembly, the first speaker device comprising at least one wireless transmission element arranged therein;
at least one second speaker device, which is provided, at one side thereof, with at least one second connection assembly that is selectively connectable to the first connection assembly, the second speaker device comprising at least one electricity storage element arranged therein; and
at least one power supply device, which is provided, at one side thereof, with at least one third connection assembly, the third connection assembly being selectively and alternatively connectable to one of the first connection assembly and the second connection assembly.

2. The multifunctional Bluetooth device according to claim 1, wherein the first connection assembly, the second connection assembly, and the third connection assembly each comprise at least one magnetic element for mutual connection with each other and at least one transmission conductor for mutual electrical connection and arranged at one side of the magnetic element.

3. The multifunctional Bluetooth device according to claim 1, wherein the wireless transmission element is structured to establish wireless information communication with at least one electronic device.

4. The multifunctional Bluetooth device according to claim 1, wherein the power supply device comprises at least one electricity storage element.

5. The multifunctional Bluetooth device according to claim 1, wherein the power supply device has an end on which at least one connection element is formed, the connection element being electrically connectable with at least one electronic device.

6. The multifunctional Bluetooth device according to claim 1, wherein the power supply device comprises at least one sound collection element mounted thereon.

7. A multifunctional Bluetooth device, comprising:
at least one first speaker device, which is provided, at one side thereof, with at least one first connection assembly, the first speaker device comprising at least one wireless transmission element arranged therein; and
at least one second speaker device, which is provided, at one side thereof, with at least one second connection assembly that is selectively connectable to the first connection assembly, the second speaker device comprising at least one electricity storage element arranged therein.

8. The multifunctional Bluetooth device according to claim 7, wherein the first connection assembly and the second connection assembly each comprise at least one magnetic element for mutual connection with each other and at least one transmission conductor for mutual electrical connection and arranged at one side of the magnetic element.

9. The multifunctional Bluetooth device according to claim 7, wherein the wireless transmission element is structured to establish wireless information communication with at least one electronic device.
